(19) United States
(12) Patent Application Publication
(10) Pub. No.: US 2004/0004633 A1
(43) Pub. Date: Jan. 8, 2004

(54) Web-based system and method for ordering and fitting prescription lens eyewear

(76) Inventors: James N. Perry, Danbury, CT (US); James Cannavino, New York, NY (US); Matthew Ettinger Oakes, New York, NY (US)

Correspondence Address: Paul J. Esatto, Jr., Scully, Scott, Murphy & Presser, 400 Garden City Plaza, Garden City, NY, 11530, US

(21) Appl. No.: 10/188,671

(22) Filed: Jul. 3, 2002

(51) Int. Cl. G09G 5/00

(52) U.S. Cl. 345/728; 345/749

(57) ABSTRACT

In a server-client web-enabled networked computing system including a database containing eyeglass frame image information for a plurality of eyeglass frames, a system and method allows for a customer to virtually try on eyeglass frames by enabling a computer system to provide an esthetically realistic rendition of the customer wearing the eyeglass frames through virtual digital imaging means for display on the customer's computer so the customer can view his/herself in the selected eyeglass frames. An eye-care professional first visits a customer at a customer location to obtain all necessary measurements and account creation data. Subsequently, the user may access the virtual try-on system. A utility enabling side-by-side comparison permits the customer to view side-by-side displays of the customer virtually fitted with esthetically realistic images of eyeglass frames to aid in choosing a preferred eyeglass frames for purchase. The customer may then purchase, without ever visiting an optical shop or like eyecare center, the selected eyeglass frames, and with a customer supplied prescription, the fitted pair of prescriptive eyeglasses may be delivered to a location designated by the customer.

### FIELD OF INVENTION

The present invention broadly relates to fitting and dispensing eyewear products such as eyeglass frames having prescription lenses, and more specifically, to a novel, Internet/Web-based system and method for trying-on, fitting and dispensing such eyewear products.

### BACKGROUND

Currently, customers who are shopping for eye-glass frames for their prescription lenses visit an optometrist's or optician's office/shop, purview the inventory of eyeglass frame wear at hand, sit down in front of a mirror and repeatedly try on different frames. One problem with this method is that to accommodate for the many different tastes, styles and eyeglass frame size requirements of customers, a wide variety of frames must always be physically present in the office. That is, the office or shop has to maintain a large inventory to reasonably service the range of all likely customers. This problem is compounded by the many different brands and styles now available rendering it virtually impossible to carry every conceivable brand/style that customer's may like. Another problem is that the amount of frames maintained for try on purposes are not available to be sold to any customer. A further problem is that the more eyeglass frames are tried on by customers, the more likely that these frames will eventually wear down, and a replacement set must be ordered, resulting in added cost to the optometrist.

Attempts to solve the problems discussed above have resulted in systems that are physically located in a store that permit the customer to electronically “try-on” the glasses and place an order. Existing prior art systems additionally require the customer to visit a digital camera equipped customer diagnostic location in order to obtain information about the customer's head, face, e.g., obtain pupillary distance measurements, and additionally acquire an image of the customer's head and/or face before the eyeglasses can be sized.

It would be highly desirable to obviate the necessity for customers to visit a digital camera equipped customer diagnostic location in order to obtain feature information about the customer's head, face, etc., and in order to capture a digital image of the customer's head and/or face so that eyewear to be purchased may be accurately sized.

It would further be highly desirable to overcome the deficiencies inherent in the prior art systems by providing a remote electronic or virtual “try-on” system that does not require the visitation of a customer to a diagnostic location at all, but rather enables user selection of eyeglass frame wear from electronic catalogs and virtual fitting of selected eyeglass frame products electronically, via a computer device at any remote location, and permits the subsequent purchase of selected and “fitted” eyewear products.

Furthermore, it would be desirable to provide a system and method that permits an optician or like eye-care professional to travel to different customer locations and obtain the necessary customer feature measurements and account information as a prerequisite for enabling subsequent customer virtual try-on of eyewear products at the customer's convenience, via a computer device at any remote location.

It would be further highly desirable to provide a remote electronic or virtual “try-on” system that does not require the visitation of a customer to a diagnostic location at all, but rather utilizes customer provided information including a digital image of the customer, e.g., uploaded from a remote computer or the customer's PC to a remote database storage facility for association with the customer's account and, wherein the customer provided digital image includes a reference object of predetermined dimension (e.g., a compact disc) for enabling optician to subsequently obtain customer feature measurements without having to visit the customer.

It would be further highly desirable to provide an electronic or virtual eyeglass frame “try-on” system that presents a digital image of the customer rendered with a superposition of an image of the customer-selected eyeglass frame wear accurately fitted to the customer, for customer viewing via that customer's own PC display, and that further provides means enabling a customer to manipulate the image of the eyeglass frame wear while superimposed on that customer's image.

It would be further highly desirable to provide a remote electronic or virtual eyeglass frame “try-on” system that presents a plurality of images of that customer each rendered with a superimposed customer-selected eyewear product, e.g., eyeglass frames, accurately fitted to the customer and capable of being manipulated on the customer's image, to enable side-by-side view comparisons for the customer viewing, thus enabling more informed selection via that customer's own PC display.

Until now, the practical reality of eyeglass frames shopping from a convenient location rather than in person, has remained elusive.

### SUMMARY OF THE INVENTION

The present invention relates to a system and method for custom fitting eyeware frame and lens products to customers without the frames and lenses being physically present, i.e., fitting eyeglasses in a virtual fitting room (a virtual digital image of the eyeglass frames) that is easily accessible via a customer's web-browser interface and display device.

After accessing images of virtually unlimited number of eyewear frame products stored in a database for selection via an electronic catalogue, or like e-catalog selection device, the system's virtual fitting room enables the customer to virtually “try-on” the selected eyewear frame products, by allowing a customer to view a displayed image of the customer fitted with a superimposed image of the customer-selected eyewear product, e.g., eyeglass frames, on a web-enabled computer. The virtual try-on imaging system and methodology provides an esthetically realistic rendering of the customer with the eyeglass frames on. This realistic imaging enables a customer to make more informed decision regarding choice of eyeglass frames from any web-enabled computer or other Internet appliance with a display interface. This system and method is further enhanced by providing utility for enabling the virtual display of esthetically realistic images of that customer fitted with different frames in a manner so that customers may make side-by-side comparisons.

Preferably, the system includes functionality utilized by an optician or like eye-care professional who travel to customer locations, and perform the necessary physical customer measurements and account data entry for customers to enable fitting of eyeglass frames or eyewear products, in addition to setting up a customer account. The optician or like eye-care professional may further assist the customer in selecting eyewear and virtual try-on of eyewear in conjunction with taking customer orders at a convenient customer location. The invention thus is directed to eliminating the need for the customer to visit any location, and only requires use of a web-enabled computer, which may be at the customer's home, or any location convenient to the customer for a complete virtual eyeglass selection, fitting, try-on, and purchasing experience.

Advantageously, the system and method of the invention for bringing the optical shop to the patient provides a simplified, lower cost operation and maintenance of optometrists/optician stores by enabling the reduction of actual eyeglass frame wear inventory on-hand, and elimination of the need for a digital camera or like digital image capture means at the store locations.

Alternately, rather than having an optician visit the customer location, the system may receive a digital image of the customer directly from the customer, e.g., uploaded from a remote computer or the customer's PC, to a remote database storage facility for association with the customer's account and, wherein the customer provided digital image includes a reference object of predetermined dimension (e.g., a compact disc) for enabling an optician to subsequently obtain customer feature measurements without having to visit the customer.

Additionally, the invention provides the capability for efficient order fulfillment and real-time status checking of customer orders.

According to the principles of the invention, there is provided a system and method for enabling customer selection of eyewear and try-on over a web-enabled networked computing system, the steps comprising: obtaining one or more digital images of a customer to be fitted with the eyewear and storing the images; performing a facial image measurement to be used for calibrating a display device to obtain facial feature dimensions for fitting the eyewear to the customer based on the stored customer's image, said measurement being performed at a location convenient to the customer by an eye-care professional; enabling a customer to select eyewear from a plurality of eyewear choices for virtual try-on via a web-enabled customer display device enabling customer virtual try-on of the selected eyewear at the web-enabled customer display device by: i) retrieving the stored digital image of the customer for display at the customer display device; ii) generating an image of a selected eyewear scaled for fitting the customer according to the obtained facial feature dimensions; and, iii) generating for display an image of the selected eyewear superimposed the over the displayed image of the customer, wherein a realistic rendition of the customer wearing eyewear fitted for that customer via the customer's web-enabled display device is provided.

Preferably, the step of performing a facial image measurement at the customer location to be used for calibrating a display device includes performing a pupillary distance (PD) measurement for that customer. Subsequently, a display device may be calibrated by an optician to obtain all remaining facial feature dimensions of the customer by performing steps of: accessing the stored customer's image and displaying the stored customer's image on a display device; demarcating two points directly on the displayed customer's image representing a PD measurement; and, mapping a number of pixels representing a linear distance between the two points on the customer's image with the obtained PD measurement to calibrate the display, wherein measurements may be made directly on said customer's displayed image for subsequent order fulfillment.

With such a system, the customer is optionally enabled to provide the imaging and measurement information remotely or at an optical store. Unlike the prior art, however, novel virtual digital imaging means and algorithms are implemented to provide a more esthetically realistic image of the customer fitted with the eyeglass frames.

Advantageously, the present invention provides customer with access to an unlimited inventory of eyewear/frame products and provides the capability of shopping for such fitted eyewear frame 24×7 conveniently via remote PC or computer device access. This permits the reduction of maintenance and operational costs associated with optometrist/optical shop inventories.

### BRIEF DESCRIPTION OF THE DRAWINGS

The present invention will now be described in more detail by referring to the drawings that accompany the present application. It is noted that in the accompanying drawings like reference numerals are used for describing like and corresponding elements thereof.

FIG. 1 is a system diagram depicting the web-based service that provides all of the tools that enable the virtual trying-on, fitting and dispensing of eyewear products such as eyeglass frames according to the present invention;

FIGS. 2(a)-2(c) illustrate exemplary web-based displays providing the Physician's desktop and Optician's interface;

FIG. 3(a) illustrates an exemplary web-based display providing functionality for entering relevant patient information and obtaining patient eyewear fitting measurements;

FIG. 3(b) illustrates an exemplary web-based Physician's Desktop display providing pupil markings of an obtained customer image for obtaining measurements as may be performed by an optical professional;

FIG. 4 illustrates an exemplary web-based display providing a customer log-in screen for accessing the virtual try-on web-site;

FIG. 5 illustrates an exemplary web-based display providing a customer interface enabling access to the eyewear catalog browse and eyewear virtual try-on functionality; and

FIG. 6 illustrates an exemplary web-based display providing a customer interface for browsing the eyewear e-catalog according to the invention;

FIG. 7 illustrates an exemplary web-based display displaying the results of a customer's eyewear search;

FIG. 8 illustrates an exemplary web-based display providing Eyewear advisor functionality to enable more focused eyewear searches according to the invention;

FIG. 9 illustrates an exemplary web-based display depicting customer selections for virtual try-on;

FIG. 10 illustrates an exemplary web-based display providing the virtual try-on interface including functionality for manipulating the images and providing side-by-side comparisons for more informed selection;

FIG. 11, there is shown an exemplary window 605 display upon selection of the patient information tab 62 shown via the Physician's desktop interface 48;

FIG. 12, each purchase transaction will appear in the Payment Queue 610. Further

FIG. 13, via account search functionality provided through interface 675, the physician's office is enabled to track a customer's order history;

FIG. 14 illustrates an exemplary web-based display providing the optician's interface 500 for enabling an optician to make all of the necessary measurements to enable the fitting of the eyeglass lenses to the ordered eyeglass frame/eyewear including a calibration page provided for the inventive eyeglass fitting method;

FIG. 15(a) shows an ocular center height measurement page of the current invention for R OD;

FIG. 15(b) shows an ocular center height measurement page of the current invention for L OS;

FIG. 15(c) shows a bridge width measurement page of the current invention of the current invention;

FIG. 15(d) shows a lens bank screen provided by the Physician's Desktop for entering in customer prescription information.

### DETAILED DESCRIPTION OF THE PREFERRED EMBODIMENTS

Voyant.com^{SM} is a web-based service that provides all of the tools that enable the virtual trying-on, fitting and dispensing of eyewear products such as eyeglass frames for registered customers. Through the inventive system, eye-care professionals are able to offer patients higher-quality complete eyewear at competitive retail prices as the eyewear products are moved from the manufacturer to the optician and shipped directly to their patients (customers).

As will be described in greater detail herein, the system and methodology includes the following main modules: 1) a Physicians Desktop for use by the physician or like eyecare professional at the physician's office or eye-care center to provide functionality for Photo Capture and customer/patient Account Creation, review/entry of Patient Information, review a Payment Queue, and tracking and review of a patient's Order History; and, 2) a Shopping Station providing functionality for enabling patients to browse the frame selection database 29, visit an Eye Health Center, or purchase a pair of prescription eyeglasses. That is, a first pre-examining stage comprises photo capture and account creation steps, the purpose of which is to create an account that can be used by the patient (customer) anytime and anywhere there is Internet access. The critical components of information that need to be captured to enable the Virtual Try-On system include: digital images, e.g., digital photographs, of customer head front and side views, for exact eyewear measurement and fitting, and, pupillary distance (“PD”) measurement including accurate PDs (monocular; distance and near). These numbers are used by the system to scale the digital eyewear frame and facial images precisely. As will be described, the eyeglass lens prescription data must be collected, for example, at an optometrist's office and then associated with the customer's account. In the preferred embodiment, an optician or like eye-care professional, may subsequently visit the customer and perform all of the feature measurements necessary for fitting eyewear products to the customer including taking or digitally capturing a digital image of the customer's face. It is understood that the prescription data and digital images of the customer may also be uploaded directly from the customer via a customer's browser-enabled personal computer or like interface device and associated with the customer's account for storage in the system customer accounts database. In connection with this embodiment, rather than having an optician visit the customer location, the system receives a digital image of the customer directly from the customer, e.g., uploaded from a remote computer or the customer's PC, to a remote database storage facility for association with the customer's account, wherein the customer provided digital image includes a reference object of predetermined dimension (e.g., a compact disc) for enabling an optician to subsequently obtain customer feature measurements without having to visit the customer.

Once the measurement data and customer images are collected, the customer may start to shop for eyewear—lens and frames—right from the doctor's office or, preferably, at any location as convenient for them. As will be described, customers may access an electronic catalog of eyewear products, e.g., eyeglass frames, and virtually “try-on” selected products via a high-resolution digital imaging technology implemented to enable the patient to view frames on their face. They may choose from hundreds of styles and frame compositions and lens features from the electronic catalog.

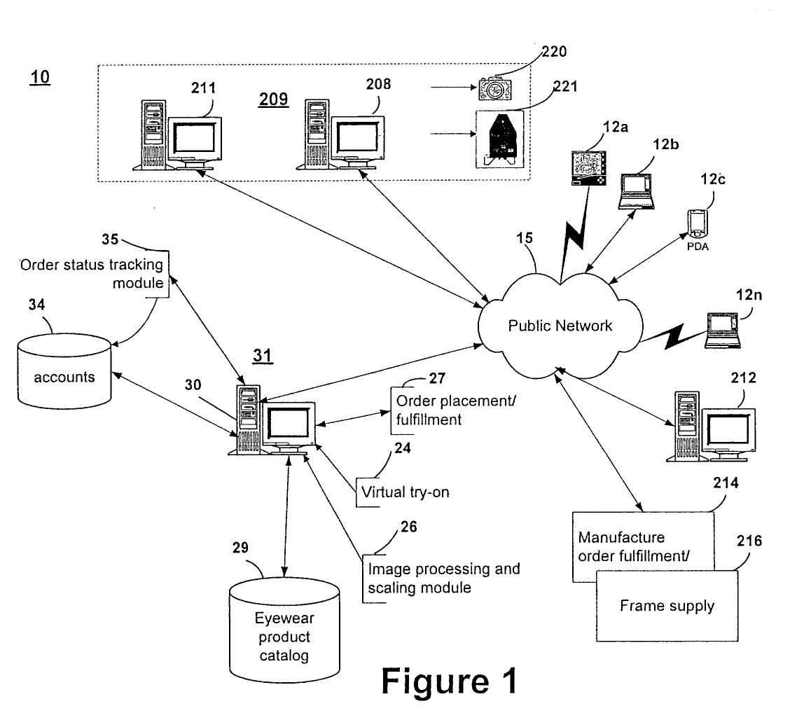

FIG. 1 is a diagram illustrating an Internet/Web-based system 10 providing functionality established for enabling virtual try-on, fitting and dispensing of eyewear such as eyeglass frame products according to the invention. As shown in FIG. 1, the invention comprises a web site 31, maintained and operated by Voyant.com^{SM}, providing the secure on-line connection service over the Internet, that includes one or more web/database servers 30 comprising application and database software components for building customer accounts. Registered customers including eyecare professionals, opticians and patients 12a, . . . , 12n of the web site are enabled to access the web site 31 remotely via wired or wireless connections to the Web/Internet 15. Wired communications between the web site 31 and the registered users are via the public Internet in accordance with standard TCP/IP protocols and optionally, over a secure communications link, e.g., secure sockets layer, BlueTooth or similar protocol. It is understood that parties 12a, . . . , 12n may access the Web/Internet via a personal computer/computing device, personal digital assistant, or like device implementing web-browser functionality, e.g., Netscape® or Internet Explorer®, or other browsing technology that may be compatible.

The Voyant.com^{SM} web-site includes one or more web-servers 30 executing a collection of web-based applications implementing, for example, Active Server Page (ASP), JavaScript, HTML, VB Script with a SQL Server database. This preferably operates on a centralized server 30 and databases 29 and 34 with 128-bit security. Provided at a web-site server 30 are various Internet Information Services (IIS) which are mechanisms enabling files on a computer to be read by remote computers and particularly, used to house, secure and present a web site to either the Internet or an intranet (private network); and Component Services (COM) which function as a repository of custom Dynamic Link Libraries (dll's) that allow custom applications to perform actions in data sources foreign to the application, e.g., enabling a web page to query data on a database.

As shown in FIG. 1, the database 34 comprises user account information for storing respective customer/patient profiles, e.g., virtual try-on customers, represented by a computer device 212, and an electronic catalog 29 providing an inventory of eyewear products that may be communicated and presented for customer selection at that customer's location. As will be described in greater detail herein, the web-server 30 preferably executes a variety of application specific programs, including, but not limited to: image processing and scaling software module 26 that enables most accurate and realistic depiction of customer images fitted with eyeglass frames for virtual try-on; virtual try-on software module 24 providing functionality for enabling presentation of realistic digital images enabling virtual try-on of eyewear products, and customer manipulation of the digital images at their home computer device (“PC”); order placement and fulfillment software module 27 enabling the placement of orders and including mechanisms for enabling credit card payment of customer orders; and, a tracking module 35 comprising software for tracking orders for eyewear products that have been placed by customers.

Physician's Desktop

A Physician's Desktop 208 provides the capability for a physician, qualified optician or like eye-care professional to input to the system information including PD calculation, lens prescription information, billing, payment and shipping information, customer log-in information, customer image information, and access information such as order status and patient history, and the like. In the preferred embodiment, this information is obtained/entered and an account created when an optician or like eye-care professional visits the patient/customer at any mutually convenient location.

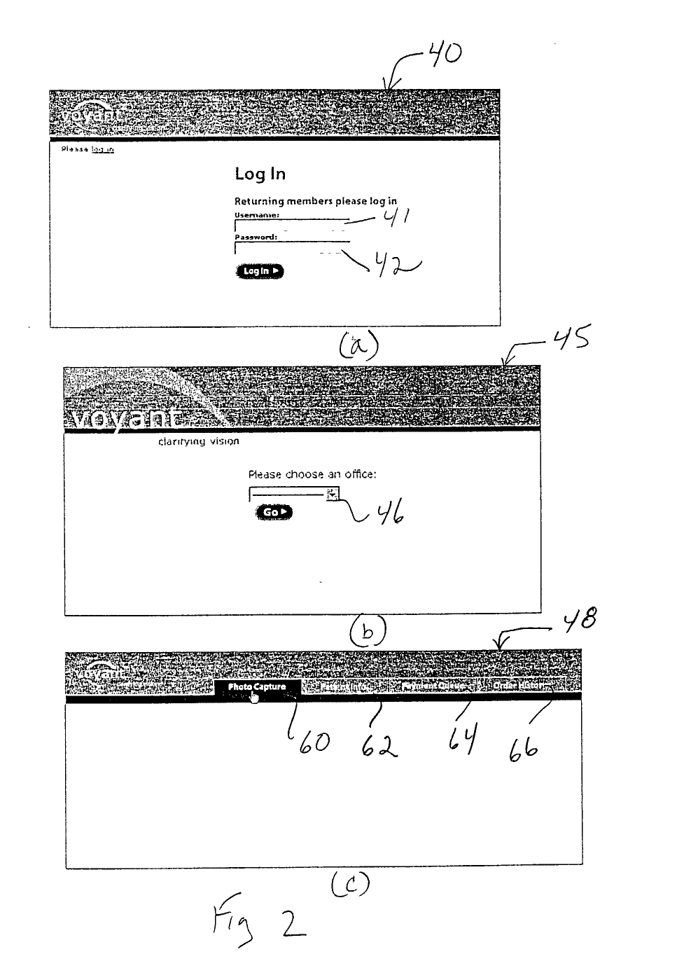

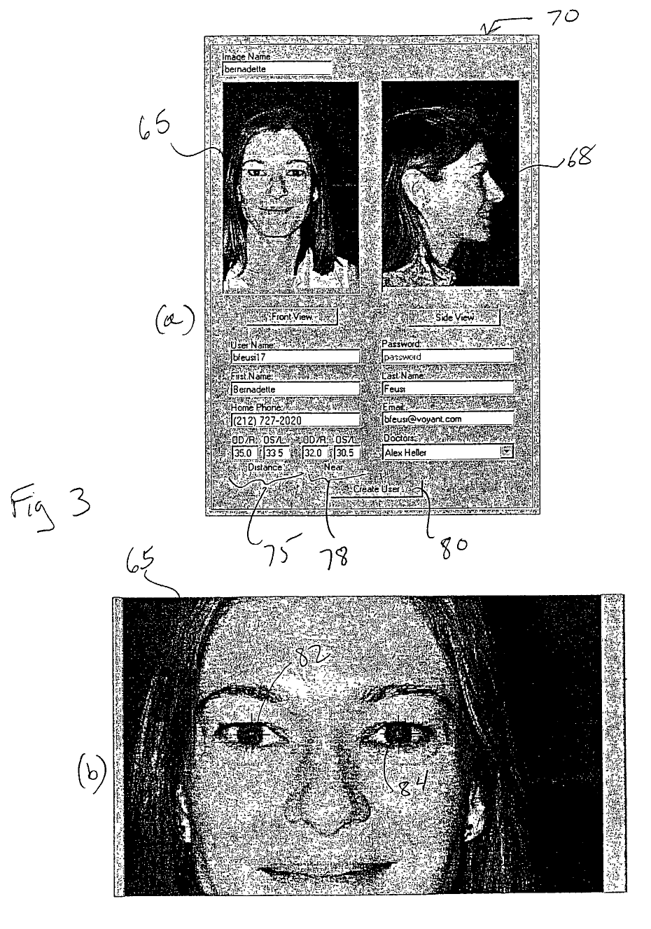

With respect to the first pre-examining stage comprising photo capture and account creation steps, the optician or like eye-care professional who are registered with the system may first Login to the Physicians Desktop interface 40 depicted in FIG. 2(a) using their administrative account name(s) 41 and password(s) 42 assigned to that office. For instance, as shown in FIG. 1, the Physician's Desktop client 208 may be accessed at an eyewear center or office 209 for the customer who chooses to visit the physician's office and use the virtual try-on system right from the doctor's office, or, preferably, as will be described in greater detail herein, may be accessed by the eye-care professional at a convenient customer location via a mobile PC or laptop. As some physicians see patients out of multiple office locations, the patient is typically associated with one office. Thus, after log in, as illustrated in the exemplary interface screen 45 of FIG. 2(b), the Physicians Desktop client is provided with a dropdown menu 46 enabling selection or entry of the appropriate Physician's office. The Physicians Desktop client main menu interface 48 is illustrated in FIG. 2(c). As shown in FIG. 2(c) the interface provides a “Photo Capture” tab 60 that may be selected to cause download of a further interface screen providing selections for launching the photo capture functionality. Particularly, as shown in FIG. 1, the physician or like eye-care practitioner is prompted to obtain a digital photograph taken at a client location by a camera such as digital camera 220 which image is directly stored in the system database and associated with the patient. Preferably, as shown in FIG. 3(a), the front view 65 of the patient's entire facial image is captured and then, a side view image 68 is captured using camera 220 in a manner to ensure that one ear of the patient is completely visible in the image. The recommended distance between the camera 220 and the patient (not shown) is 4 to 8 feet, although an exact distance is not required. The image information is then made available to the Physician's Desktop computer interface 208 where, via window screen display 70 such as shown in FIG. 3(a).

Further via the interface 70 depicted in FIG. 3(a), the practitioner or eye-care professional at the office or, preferably, at the customer location, may create a user account comprising the obtained digital images of the customer's front and side views, specifically, by entering patient's/customer's first and last names, phone number, e-mail address are entered as the user name, and a default password given. The customer will be prompted to change their password the first time they use their account. It should be understood that the customer may provide a digital photo image or upload a digital photograph image of the customer to the Physician's desktop, via any conventional means known in the art. If the customer chooses to provide their own digital image, it is essential that a reference object of known size, for example, a compact disc, be included in the image so that the optician may calibrate a display to obtain accurate feature measurements of the customer to be fitted with eyewear. Such a system is shown and described in co-pending U.S. patent application Ser. No. 09/713,951, the contents and disclosure of which is incorporated by reference as if fully set forth herein.

In a subsequent step, the physician makes a Pupillary Distance (PD) measurement of the patient/customer using the pupilometer 221, as shown in FIG. 1 either at the physicians office, or preferably, at the customer location. If the user submits an image with a reference object, the PD measurement may be performed anytime by an optician. A monocular PD is preferably required. As described herein, the PD is used to scale the photo to the precise size needed to view the photo and for the optician to make the proper fitting measurements. At this step, a first distance PD measurement is taken for measuring the distance between the centers of the pupils when they are focused on a distant point. The setting on the pupilometer should be at infinity (∞) when taking this measurement. The distance PD is then recorded and entered in the entry boxes 75 marked “Distance” as shown in the create user interface 70 of FIG. 3(a). Then, a near PD measurement is taken for measuring the distance between the centers of the pupils when they are focused on a near point. The setting on the pupilometer should be at 40, for example, when taking this measurement. The near PD is then recorded and entered in the boxes marked “Near” 78 as shown in FIG. 3(a). Then, the physician or practitioner is prompted to select the “Create User” button 80 which presents a next screen display to the physician, a portion of which showing the digital image of the patient's face, is shown in FIG. 3(b). Optionally, via the physician's desktop interface 208, the user may be prompted to crop the photograph to suitable size, whereby, starting at a top left corner of the patient's digital image, the mouse cursor may be dragged diagonally down to the bottom right corner to draw a box over the area that should be included in the photo. Whether cropping is performed or not, the next step enables the physician to mark the pupillary center for enabling the frames to be properly aligned on the image during the virtual Try On. Specifically, as shown in FIG. 3(b), the optician is prompted to place the mouse over the pupillary center 82, 84 of each eye of the patient's front facial image 65, and set the crossbar at the center of each pupil by left-clicking the mouse once for each eye. As will be described herein, the pupil markings 82, 84 provide a means for calibrating the image to facilitate fitting the frames and lenses for the shop from home feature. The new account information and photograph (digital image) is then saved in the system account database 34 (FIG. 1).

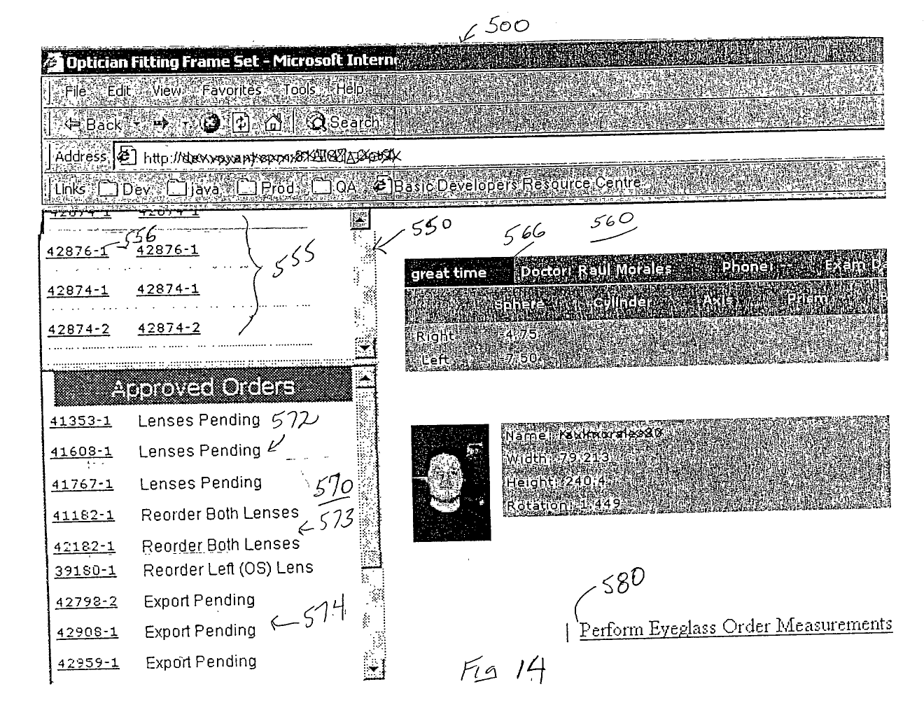

As further illustrated in FIG. 11, there is shown an exemplary window 605 display upon selection of the patient information tab 62 shown via the Physician's desktop interface 48 of FIG. 2(c). This interface 605 includes fields enabling entry of the customer's prescription information including: a name of the lens prescription 606 or like description of its function (e.g., reading glasses); and, the complete set of the customer's lens prescription values 608 for each eye including sphere, cylinder, axis, prism, base and add values. Additional comments may be added for any special prescription (e.g. asymmetrical pupillary distance). This add lens bank feature (FIG. 11 at 605) is included for adding each new prescription information about a customer and, may further be provided to the customer via the Eyewear Center interface described in greater detail herein. By clicking the “add to lens bank” button 610, the prescription information is associated with the user account and accordingly stored for the patient/customer and accessible via the customer accounts database 34 of FIG. 1. At any time, the registered physician or eye-care professional may view and/or change information about the patient, for example, Add required prescription information for lenses, or, Change Address Information, e.g., the address to where the patient's glasses are to be shipped.

The newly created customer account is immediately accessible by the patient over any Internet-connected computer. In the doctor's office, it is accessible from the shopping station client device 211 as shown in FIG. 1. From the patient's location, e.g., home or office, the account is accessible by entering the system web-site at www.voyant.com, e.g., via a home PC 212 or portable laptop client 12a, 12b, etc.

Eyewear Center

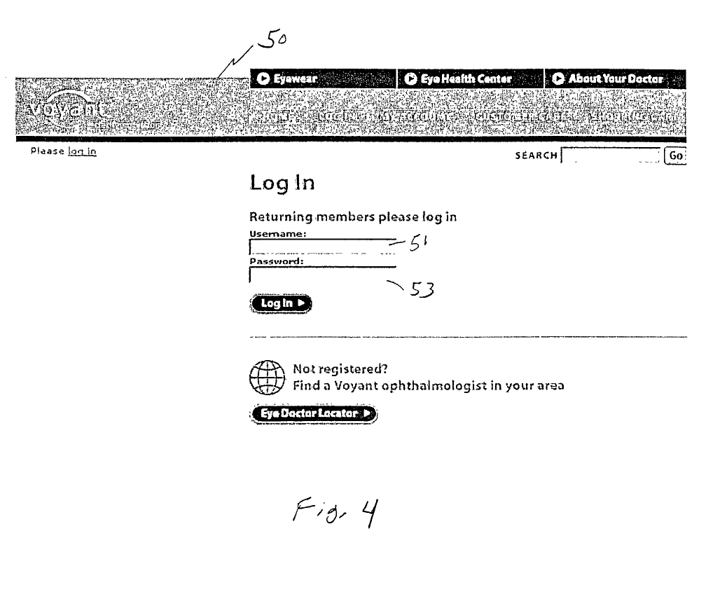

As mentioned, when the patient concludes the examination with the doctor, the individual is invited to select their eyewear or peruse an Eye Health Center for informative articles accessible by the patient from the physician's office or, subsequently from their own personal computer. With respect to the functionality for enabling patients to browse the frame selection database 29, visit the Eye Health Center, or purchase a pair of prescription eyeglasses, reference is first made to the logon screen of FIG. 4. FIG. 4 particularly illustrates an example Voyant.com^{SM} log-in web-based communication (e.g., web-page 50) including a username field 51 and password field 53. Users may access the system using a pre-assigned username and password. If a registered user has forgotten their password or user name, user may retrieve this information via e-mail using a well-known forgotten user password function. The username may be automatically generated based on the user's first name and last name.

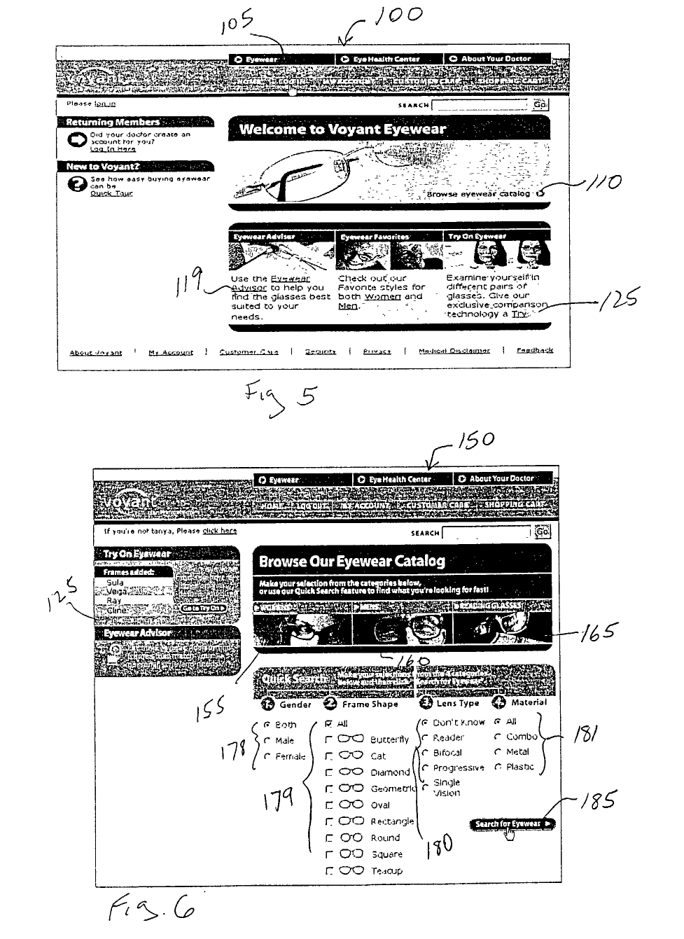

As shown in FIG. 5, upon logging in to the Voyant.com^{SM} website, the user is presented with a web-based communication including an interface 100 providing Eyewear center functionality 105 including a user selection 110 for enabling the browsing of eyewear through the on-line catalog, and frame/Try On/retail functionality according to the invention. Specifically, the Eyewear Center 105 incorporates functionality for implementing the Try On technology 125 enabling side-by-side realistic views to enable comparisons of what the eyeglass frames look like on the customer. The Eyewear Advisor option 119 as shown in FIG. 5 provides the browse functionality to enable access to the on-line catalog of eyewear frame products. Further options including functionality for e-mailing a photo to third parties, e.g., to have friends and family see what frames the patient is interested in; the Print photo option to take home the Try On image and account information; and, delivery enabling the choice of manufactured eyewear delivery methods, e.g., shipping directly to home or doctor's office, etc.

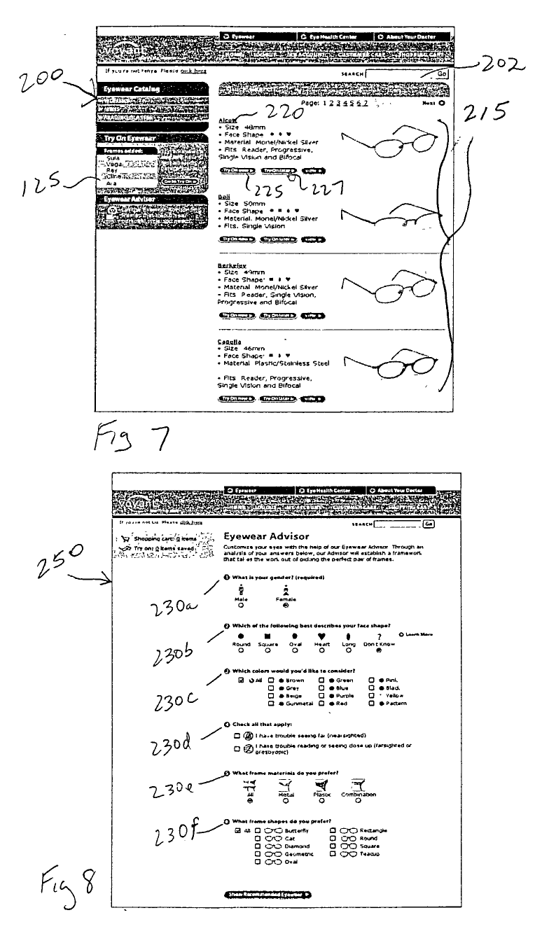

As shown in FIG. 6, upon selection of the eyewear browse function 110 of FIG. 5, the user is presented with a web-based communication including an interface 150 providing functionality enabling the browsing of eyewear through the on-line catalog. FIG. 6 particularly the illustrates the customer interface 150 presenting the on-line eyeglass frame catalog enabling broad frame search categories 155,160 for selecting the eyewear category or, a choice 170 for selecting reading glasses. Quick search functionality 175 is additionally provided if the patient has a preferred frame shape, material or color. For instance, to narrow the frame selection, specific quick search functionality enables specific customer selection of: genre 178, including selection boxes for selecting male, female or unisex categories; frame shape 179 including selection boxes for selecting shapes such as butterfly, cat, diamond, geometric shapes, oval, etc.; a lens type 180 including selection boxes for selecting bifocals or progressives etc.; and, a material 181 such as metal or plastic. It should be understood that selection of a Lens Type will limit the search results to frames that are compatible with specific prescription fulfillment options, e.g., bifocal or progressive lenses.

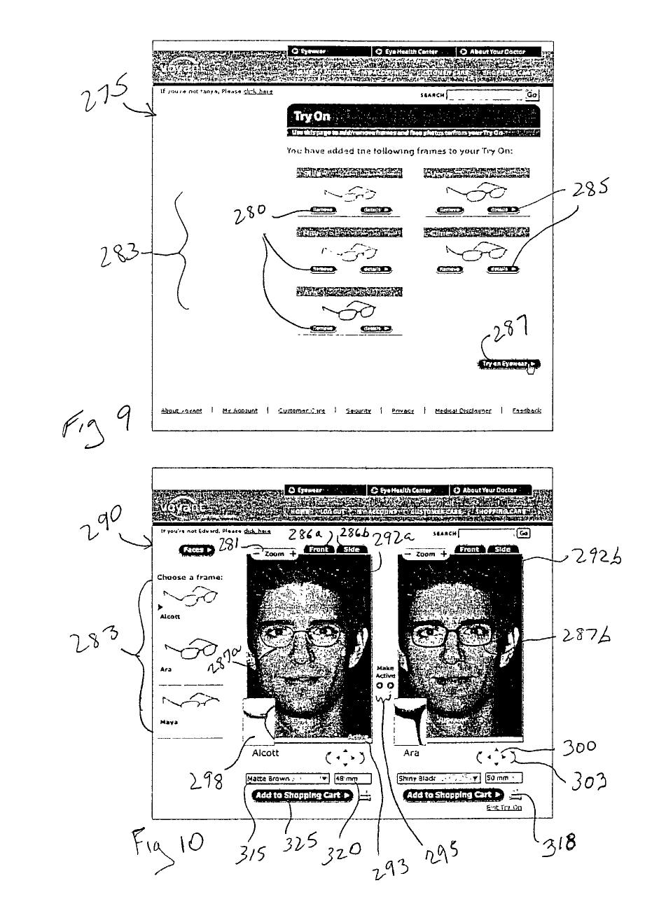

Once the desired values are entered, the user may select the Search for Eyewear option 185 to obtain the e-catalog search results which are presented to the user via the web-based communication depicted in FIG. 7. This communication provides an interface 200 for the eyeware catalog. If the customer knows the name of a specific desired frame, the customer may enter it in the search box 202 provided. From the list of search results 215 provided to the user, the user may click on the frame's name 220 to initiate generation of a pop-up window (not shown), for example, populated with more details about the specific frame. At this point, the customer may initiate the try-on functionality immediately by selecting Try-on button 225 or 125 from each downloaded interface, or, may initiate a “set-aside” feature for storing selected frame choices for try on at a later time, for example, by selecting the try-on later function 227.

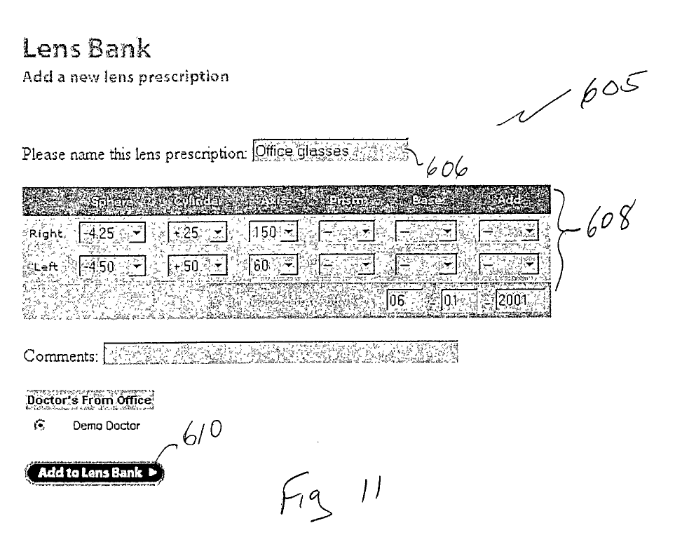

At any time in the process, if the patient is unsure of preferences, the “Eyewear Advisor” may be used to suggest suitable frames. The advisor is an interface 250 as enabled by the web-based communication depicted in FIG. 8 where a user may provide answers to certain questions 230a-230f commensurate with the quick search selections 178-181 provided via the browse interface 150 of FIG. 6. In response to customer answer choices, the system builds a framework to assist the customer by providing eyewear selections in the search catalog 200 of FIG. 7.

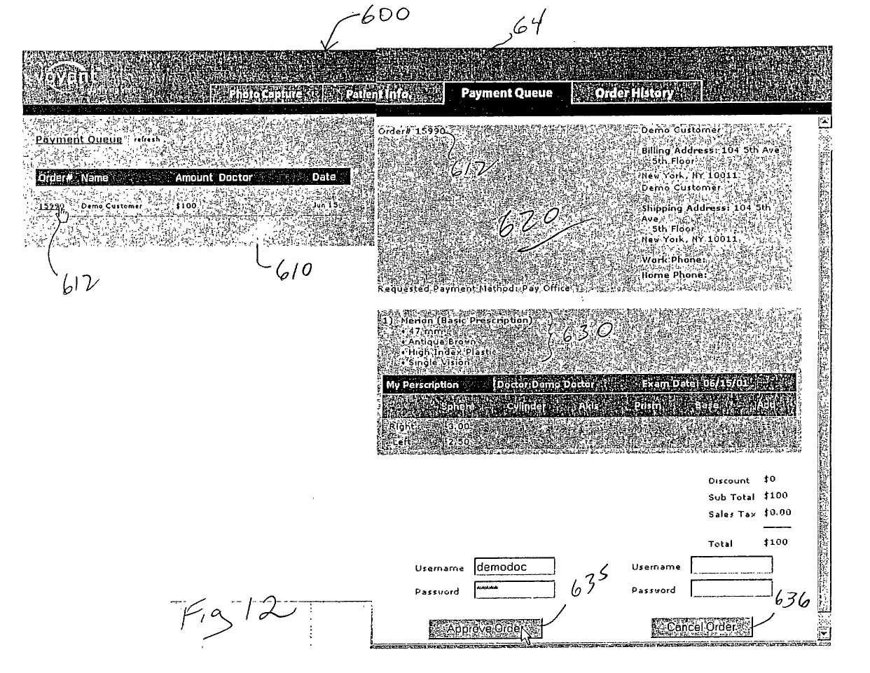

Once all frames that have been selected while browsing are displayed, the user may inititate the try-on functionality, which causes downloading of a web-based communication as depicted in FIG. 9 and providing the try-on interface 275. As shown in FIG. 9, the try on interface 275 is a window providing all frame choices 283 that have been previously selected by the user and were stored in response to selection of the “try-on later” selection buttons 227 provided via the selection interface 200 of FIG. 7. In FIG. 9, functionality is provided to eliminate frames from the Try On, for example, by customer clicking a “Remove” button 280 associated with each frame choice to help narrow down the customers frame choices. The user may additionally view details about a selected frames' features, by clicking on a respective “Details” button 285. To see the frames on the patient's image, the customer may click on the “Try On Eyewear” button 287.

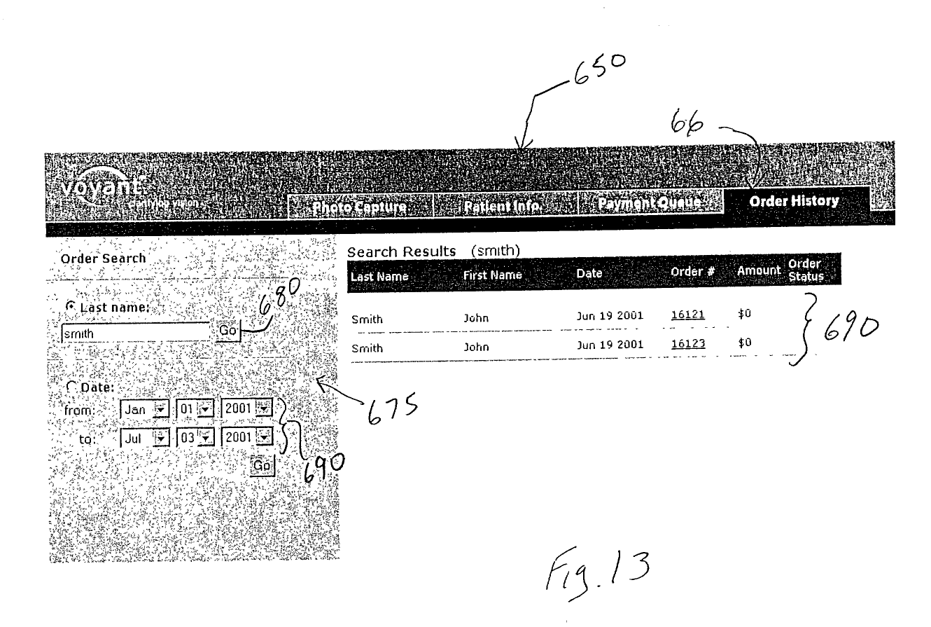

In response to the “Try On Eyewear” button selection 287, a download of a web-based communication is initiated to provide the try-on eyewear interface 290 as depicted in FIG. 10. The try-on interface initiates virtual try-on functionality as executed by virtual try-on software module 24 running on the web-site server 30 (FIG. 1). As shown in FIG. 10, the software initially involves generating and downloading to the customer's interface digital images of the first two frames 287a,b in the selection list 283, superimposed on the customer's face in respective side-by-side images 292a, 292b. Selecting one of the front 286a or side 286b enables the generation of the respective customer digital images previous captured. As explained, a number representing real world measurement vs. number of pixels in the provided image information is used to determine the fitted images for display to the customer, in the manner as will be explained. That number, which is a calibration, may also be used to provide the PD which aids in fitting the eyeglass frames to the customer. To maximize the Try On experience via interface 290, several options are available: 1) the customer may click on any frame from the frames list 283 to see them appear on the digital image of the customer. The new frames will appear in the window 293 marked “Active” in the bottom right corner. To make a window “Active”, the customer may click anywhere in the desired window or, click on one of two arrows 295 with each arrow corresponding to a respective image 292a, 292b under the heading “Make Active” 297. To get a closer look at the frame's color, material, or endpiece details, the customer may click on an inset box 298 provided at the bottom left corner in each side-by-side image. By clicking on the inset box again, the customer is returned to the user's image. In a preferred implementation of the invention, the customer has the capability to adjust a position of the superimposed eyeglass frame image 287a relative to the fixed digital image of the customer's face on the display by using the compass arrows 300 and rotary arrows 303 below each image. Respectively, selection of the compass arrows 300 enable movement of the superimposed eyeglass frame image 287a, b relative to the customer's facial image in the selected direction, and rotary arrows 305 enable rotation of the superimposed eyeglass frame image 287a,b in the indicated direction. This functionality provides the ability to create a most realistic view of the eyewear superimposed on the customer's image. That is, according to the example try-on interface shown in FIG. 10, the calibration number and geometric transforms allow a preferred implementation of the current invention to provide a one-to-one image-to-real size ratio. This one-to-one image functionality provides the truest sense of scale. Additional functionality is provided to enable image zoom in/zoom out by user selectable “±” zoom in or out button 281.

It should be understood that, via the try-on eyewear interface 290, the customer may additionally select frame colors and frame sizes from respective color or size pull-down menu options 315, 320 below the images if those color/size options are available for the selected eyeglass frame choice. Upon selection, the respective color and size of the frame eyewear image superimposed upon the customer's digital image will automatically change to reflect the selected color/size choice scheme. The customer may specifically click on the drop down arrow in the options 315, 320. To initiate printing of a picture of the user wearing the selected frames, the customer may click the printer icon 318 underneath the respective image 292a,b. It should be understood that the customer may continue to try-on all selected frame choices in one or more sessions, and further initiate viewing of any two frame choices in side-by-side manner as depicted in FIG. 11.

Using Eyewear center GUI 212 the customer may additionally select the coating types, and tint options, typically as an eyewear “add-on” option. Preferably, the try-on application, which includes the GUI, is equipped with the familiar web browser MACROMEDIA FLASH™ plug-in for maximum compatibility with a variety of clients. Through customer GUI 212, or optionally, Eyewear Center interface 211, many subtle details of the selected eyeglass frame may be observed such as, for example, tinting, and frame color.

To enable purchase selection after the desired frames are finally chosen for purchase, the try-on interface is provided with an “Add to Shopping Cart” button 325. After selecting one or more pairs of frames, information about the lenses, billing, and shipping is to be provided by the customer. Thus, the customer is prompted for the following information: Lens Prescription—the prescription or reading strength for the lenses, for example, via the add lens bank interface shown in FIG. 11; Lens add-on Options such as multifocal options (if available) and lens materials such as anti-reflective coating or high quality plastic, etc. via other interfaces (not shown); and, billing information, i.e., how the eyewear will be paid; and, shipping information, where the eyewear will be sent. That is, from a typical shopping cart interface, the user will be prompted to enter all shipping information, i.e., specifying where the manufactured eyeglasses are to be delivered.

Once the customer has placed the order into a shopping cart, for example, by placing icons representing selected items for purchase into the shopping cart, and designated check out and payment of all items in the shopping cart, the appropriate measurement data is sent to the lens manufacturer and available for virtual fitting by an Optician.

Optician's Interface

As shown in FIG. 1, the frame and lens are preferably assembled at a manufacturing/fulfillment center 214 associated with the system. Via a dedicated workstation, or a remotely located web-enabled client device, e.g., client 12a, 12b, etc., an Optician registered with the system is engaged to make the initial adjustment of the customer's frame image to fit the person based on measurements taken from the captured digital images—both front and side views. Adjustments based on these precise digital measurements are more accurate than traditional estimations. Further, this information is used for the manufacture of the eyeglass lens. Once assembled and custom-adjusted, the eyewear is shipped right to the patient's home via the order fulfillment center.

That is, an optician may access the captured image and related information of the customer's face to calculate the necessary measurements such as the pupillary distances PD in the manner as described herein. The optician may perform the measurements directly on the digital image made available via the Optician's Interface display. Measurements are particularly significant for patient's being fitted with multifocal lens to avoid optical distortions that could cause great discomfort for a wearer.

Preferably, the PD calculation may be provided automatically by digital computer means once an image calibration has been performed, and may be performed when a user submits a digital image with a reference object. That is, a number representing real world measurement is calibrated to correspond to a number of pixels in the provided image. This information is used to determine the dimensions of the eyeglass frame images to be fitted and superimposed on the image of the customer's face. That number, which is a calibration, may also be used to provide the PD which aids in fitting the eyeglass frames to the customer. As will be described, the calibration number may also be used to calculate a segment height, i.e., right ocular center height, left ocular center height, etc. These values, once computed, are entered automatically on a chart associated with the customer's prescription.

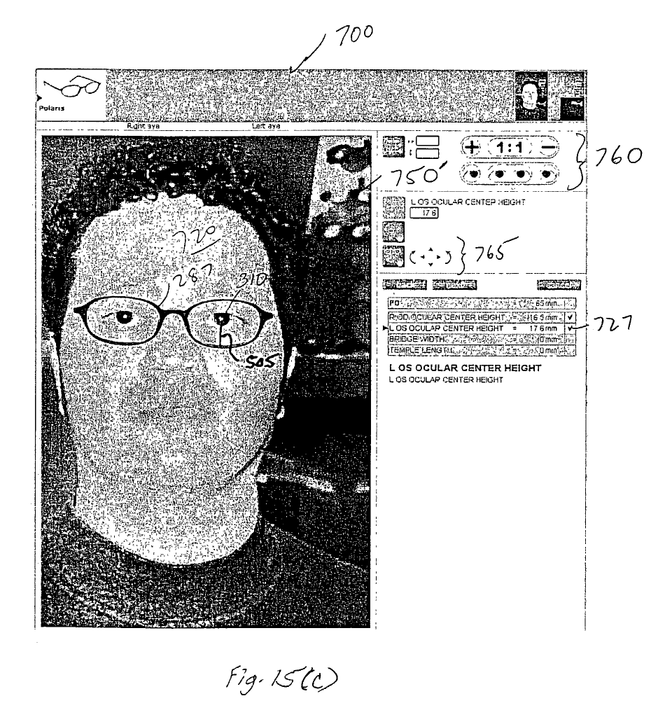

An Optician's Interface 500, an example display of which is shown in FIG. 14, is provided to enable the optician to make all of the necessary measurements to enable the fitting of the eyeglass lenses to the ordered eyeglass frame/eyewear. As shown in FIG. 14, the optician's interface 500 includes a first frame portion 550 comprising a queue 555 of those customer orders for eyewear that have not yet been approved and that await processing, i.e., calibration and final measurements, by the Optician. In a second frame portion 560, associated with a selected order 556 is the prescription information 566 of the corresponding customer that had been provided via the physician's desktop. From this frame portion, the optician may select the perform eyeglass order measurements link 580 in order to provide the required calibration and final measurements. A third frame portion 570 of the optician's interface 500 comprises a queue 575 of those customer orders for eyewear that have been approved by the physician and have associated status including: 1) lenses that are currently being manufactured, i.e., are pending 572, lenses that have to be reordered 573, lenses that have been exported to for final assembly 574, and the like. The physician's office may access this display to ascertain the status of any particular customer's order.

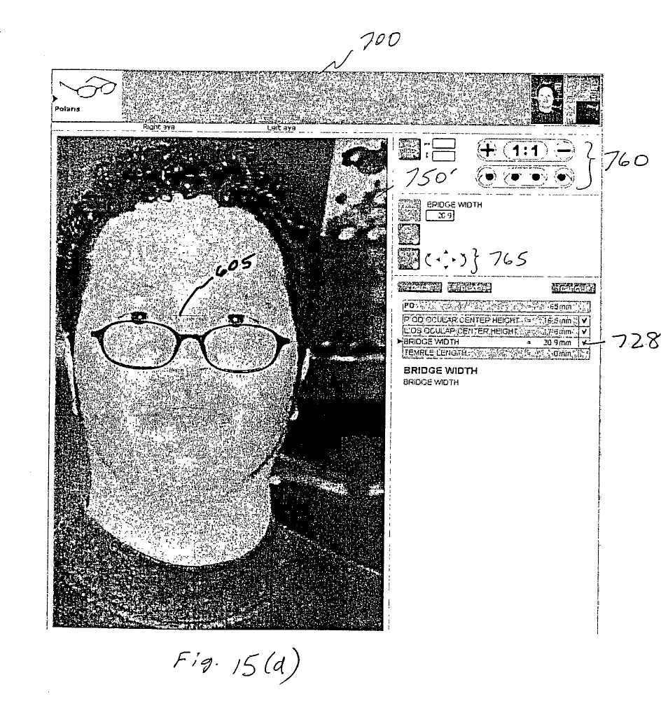

In response to selection of the perform eyeglass order measurements link 580 of FIG. 14, there is generated for display via the optician's interface a display 700 a workspace for enabling the calibration and final measurements, by the Optician. As shown in FIG. 15(a), via workspace 710, an image calibration step may be performed to enable precise final measurements performed by the optician via the interface. From this interface, the optician is instructed to electronically superpose a calibration distance in the form of a line between the customer's pupils on the customer's image 720. Implementing a cursor via a mouse device, for instance, a graphic “rubber: line 305 may be directly superimposed on the facial image 720 between the customer's pupils 310. The associated length of the drawn line 305 is then associated with a number pixels and corresponds to the pupillary distance (PD) obtained from the real-world PD measurement obtained by the physician. This PD distance 725 is already known as indicated in the interface frame 730. That is, upon selection of the image calibration button 727, the measured PD distance is mapped with the drawn line 305 to obtain the calibration for the drawing tool functionality provided via the optician's interface. To better aid the optician, a zoom feature 760 is provided to enable more exact measurements as appropriate. The algorithm invoked for scaling of the frame image on the customer's face is tracked so that the integrity of the calculated mapping to the real-world PD measurement is preserved.

Then, upon selection of the next button 733 in FIG. 15(a), there is generated for display via the optician's interface 700 a workspace 750 including the digital image of the user shown with the eyeglass frame eyewear 287 fitted. Preferably, orders are fulfilled based on the point where the frames were last positioned on the customer's face via the eye-center try-on screen depicted in FIG. 10. If the positioning is misaligned, the optician may correct the position of the frame image 287 on the facial image 720 using vertical and horizontal translation and rotation positioning functionality 765. As shown in FIG. 15(b), from the workspace 750, the optician may electronically conduct a measurement by drawing a line 405 superimposed upon the digital image that spans the distance between the customer's pupil 310 and the bottom of the virtually fitted eyeglass frame 287 to perform a right Oculus Dexter (OD) ocular center height measurement 726. Similarly, as shown in FIG. 15(c), from the workspace 750′, the optician may electronically conduct a measurement by drawing a line 505 superimposed upon the digital image that spans the distance between the customer's pupil 310 and the bottom of the virtually fitted eyeglass frame 287 to perform a left Oculus Sinister (OS) ocular center height measurement 727.

Further from this interface 700, as shown in FIG. 15(d), the optician may electronically conduct a measurement by drawing a line 605 superimposed upon the digital image 720 that spans the width of the customer's nose bridge to obtain the bridge width measurement 728. Although not shown, from the digital image of the customer's side view, the optician may electronically conduct a measurement by marking points and drawing a line that spans the temple length of the customer therebetween for superposition upon the digital image. Preferably, temple length is gauged, not algorithmically calculated. Thus, a geometric equation may be easily implemented to calculate side measurements based on frontal measurements. Further appropriate geometric transformations are provided for proper scaling. It is understood that additional image cropping may be performed by the Optician, if necessary, to aid in the measurements.

Advantageously, the virtual measurements performed in accordance with the invention are more accurate than “in person measurements”. That is to say, error prone, sloppy measurement processes may be eliminated. Similarly, the resolution of the image received may be high for greater precision in scaling. Finally, optimum positioning is provided by including tight tolerances for measurements such as the segment height, for example. Additionally, once the fitted images have been determined, a specialized algorithm executing in accordance with the image processing and scaling module 26 (FIG. 1) executing on web-site 30 processes the images to be downloaded for display. This algorithm, known amongst skilled artisans as a transparency algorithm, is a software solution commonly used in flash programming where one image is overlaid onto a second image. This algorithm is thus responsible for creating the virtual image display that includes an esthetically realistic rendition of the customer wearing the eyeglasses, virtually indistinguishable from a photograph taken of the customer wearing the selected eyeglass frames.

Referring back to FIG. 1, there is additionally shown the interrelationships among the various business entities required for customer order fulfillment. Throughout the life-cycle of a customer order, lens and frame order status information is kept and maintained to provide the customer with up-to-date information regarding the customer's order for fitted eyeglass frames. The website server's order placement/fulfillment module 27 (FIG. 1) provides functionality enabling the checking and updating of order status by communication with the lens manufacturer/fulfillment center 214, and frame supplier 216. The server 30 coordinates providing information required by the frame supplier for supplying the frame to the manufacture/fulfillment center 214. Similarly, the server 30 provides customer information required by the lens manufacturer 214 for manufacturing and routing the lenses to the fulfillment center 214. Preferably, all of the necessary measurements for lens manufacturing and fitting are routed, e.g., via e-mail, to the lens manufacturer 214 and to the frame supplier 216. When lenses go to the fulfillment center 230 the order is in wait status. Once the fulfillment center 214 receives from the frame supplier 216, the lens and frames are assembled and shipped, to the previously customer specified billing address, thus completing the customer fulfillment cycle.

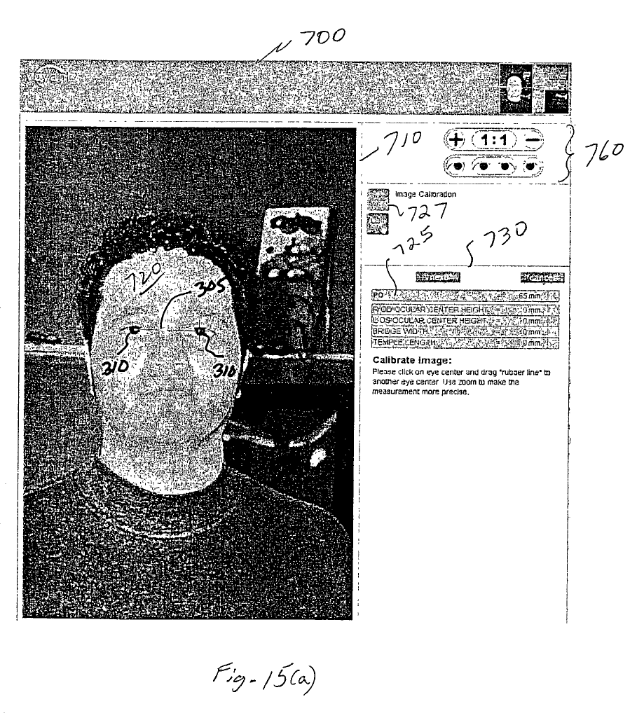

It should be understood that, post-examination, the physician's desktop 48 of FIG. 2(c) provides functionality for informing the Physician's office of those purchase transactions that have not yet been processed. That is, by selecting the Payment Queue tab 64 of FIG. 2(c), an interface 600 on the main Physicians Desktop screen is displayed comprising a queue 610 of those purchases requiring authorization from the Physician's office before they are processed. The payment queue 64 has a dual purpose: 1) to notify the physician of pending purchases, so that the Physician's office can collect the appropriate payment from the patient; and, 2) to review and validate the patient information for the sales orders. Preferably, as shown in FIG. 12, each purchase transaction will appear in the Payment Queue 610. Further, an e-mail notification may be sent to the practicing Physician's office e-mail address. As shown in FIG. 12, by selecting an order 612 from the queue, corresponding information 620 is displayed via the physician's desktop including the customer's billing address, shipping address and relevant contact information, and additionally, information including regarding the customer's selected eyewear (eyeglass frame) choice 630 including that customer's prescription information. The physician is then prompted to approve the order or cancel the order by selecting respective approve order button 635 or cancel order button 636.

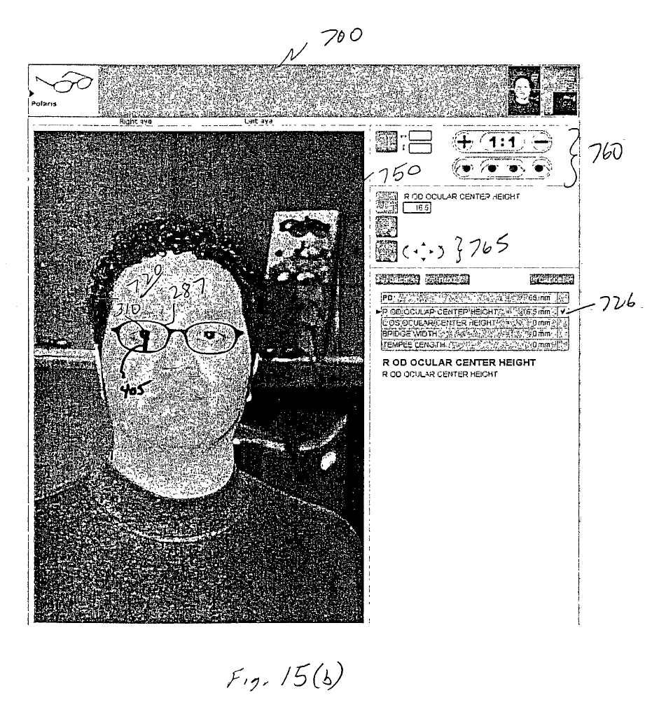

Further, with respect to the physician's desktop 48 of FIG. 2(c), there is provided functionality for managing patient sales orders and payments. Specifically, by selecting the Order History tab 66 of FIG. 2(c), the physician's office or eyecare service center 209 workstation GUI is provided with a display 650 indicating a Patient Order History. That is, as shown in the example web-based display shown in FIG. 13, via account search functionality provided through interface 675, the physician's office is enabled to track a customer's order history for any time period entered by entering the search terms including the customer's last name 680 and applicable time period 690. In response, the system generates for display the history 690 of all sales transactions made by a particular patient. As explained in greater detail, via the physician's interface, the physician's office may additionally check on the status of an order after it has been approved via the order status tracking module 35 of FIG. 1.

Now that the invention has been described by way of a preferred embodiment, various modifications and improvements will occur to those of skill in the art. Thus, it should be understood that the preferred embodiment is provided as an example and not as a limitation. The scope of the invention is defined by the appended claims.

1. A method for enabling customer selection of eyewear and try-on over a web-enabled networked computing system comprising the steps of:
a) obtaining one or more digital images of a customer to be fitted with said eyewear and storing said images;
b) performing a facial image measurement to be used for calibrating a display device to obtain facial feature dimensions for fitting said eyewear to said customer based on the stored customer's image, said measurement being performed at a customer location by an eye-care professional;
c) enabling a customer to select eyewear from a plurality of eyewear choices for virtual try-on via a web-enabled customer display device;
d) enabling customer virtual try-on of said selected eyewear at said web-enabled customer display device by:
i. retrieving said stored digital image of said customer for display at said customer display device;
ii. generating an image of a selected eyewear scaled for fitting said customer according to said obtained facial feature dimensions; and,
iii. generating for display an image of said selected eyewear superimposed over said displayed image of said customer,
wherein a realistic rendition of the customer wearing eyewear fitted for that customer via the customer's web-enabled customer display device is provided.

2. The method as claimed in claim 1, wherein the step b) of performing a facial image measurement to be used for calibrating a display device includes performing a pupillary distance (PD) measurement for that customer at a customer location.

3. The method as claimed in claim 2, wherein said calibrating a display device for obtaining said facial feature dimensions for fitting comprises the steps of:
accessing said stored customer's image and displaying said stored customer's image on a display device;
demarcating two points directly on said displayed customer's image representing a PD measurement; and,
mapping a number of pixels representing a linear distance between said two points on said customer's image with said obtained PD measurement to calibrate said display, wherein further facial feature measurements may be made directly on said customer's displayed image given said mapping.

4. The method as claimed in claim 1, wherein said step d) of enabling customer virtual try-on is either remote from or at said customer location.

5. The method as claimed in claim 1, wherein said step of calibrating a display device for obtaining said facial feature dimensions for fitting is performed by an eye-care professional via a web-enabled display device.

6. The method as claimed in claim 5, wherein said step of calibrating a display device is performed by an optician, remote from said customer location.

7. The method as claimed in claim 1, wherein said step of enabling customer virtual try-on includes: enabling said customer to manipulate said scaled image of said selected eyewear relative to said displayed image of said customer to fit said eyewear to said customer digital image.

8. The method as claimed in claim 7, wherein said step of manipulating said image of said selected eyewear includes enabling lateral or vertical adjustment of said scaled image of said selected eyewear relative to said displayed customer image.

9. The method as claimed in claim 7, wherein said step of manipulating said image of said selected eyewear includes enabling rotational adjustment of said scaled image of said selected eyewear relative to said displayed customer image.

10. The method as claimed in claim 1, wherein the step d) of enabling customer virtual try-on of said selected eyewear at said web-enabled customer display device further includes: causing for display at said customer display device two images of said customer each image superposed with a different selected eyewear to enable comparison shopping for said customer.

11. The method as claimed in claim 3, further including the step of enabling customer purchase of said selected eyewear after virtual try-on.

12. The method as claimed in claim 11, further comprising maintaining an account for the customer including personal information of a customer to facilitate said customer purchase and order fulfillment of said selected eyewear.

13. The method as claimed in claim 12, wherein said step of maintaining a customer account comprises:
receiving and storing lens prescription for that customer to be used for manufacturing lenses fitted for purchased eyewear;
receiving and storing information for billing said customer; and
receiving and storing information for delivery of eyewear to the customer, said lens, bill to, and delivery information being used to facilitate purchase and order fulfillment of the selected eyewear by the customer.

14. The method as claimed in claim 13, wherein subsequent to customer purchase of selected eyewear, the step of obtaining further measurements for generating a prescription lens to be fitted for said eyewear according to said customer's prescription, said measurements obtained directly from a displayed image of said selected eyewear superimposed over said displayed image of said customer.

15. The method as claimed in claim 14, wherein the step of obtaining further measurements for generating prescription lens is performed by an optician from a web-enabled display device, said measurements including one or more selected form the group comprising: OD measurement, OS measurement, and a nose bridge measurement.

16. The method as claimed in claim 12, further comprising the step of tracking lens and eyewear frame order status for permitting the customer to receive notifications regarding that customer's order.

17. A system for enabling customer selection of eyewear and try-on in a web-enabled networked computing environment, said system comprising:
a) means for obtaining one or more digital images of a customer to be fitted with said eyewear and means for storing said images;
b) means for calibrating a display device to obtain facial feature dimensions for fitting said eyewear to said customer based on the stored customer's image;
c) means for enabling a customer to select eyewear from a plurality of eyewear choices for virtual try-on via a web-enabled customer display device;
d) means for enabling customer virtual try-on of said selected eyewear at said web-enabled customer display device through:
i. means for retrieving said stored digital image of said customer for display at said customer display device;
ii. means for generating an image of a selected eyewear scaled for fitting said customer according to said obtained facial feature dimensions; and,
iii. means for generating for display an image of said selected eyewear superimposed over said displayed image of said customer;
wherein a realistic rendition of the customer wearing eyewear fitted for that customer via the customer's web-enabled customer display device is provided.

18. The system as claimed in claim 17, wherein the means for calibrating includes performing a pupillary distance (PD) measurement for that customer performed by an eye-care professional at a customer location.

19. The system as claimed in claim 18, wherein the means for calibrating a display device for obtaining said facial feature dimensions for fitting comprises;
means for accessing the stored customer's image and means for displaying the stored customer's image on a display device;
means for demarcating two points directly on said displayed customer's image representing a PD measurement; and,
means for mapping a number of pixels representing a linear distance between said two points on the customer's image with said obtained PD measurement to calibrate said display, wherein further facial feature measurements may be made directly on said customers' displayed image given said mapping.

20. The system as claimed in claim 17, wherein said means for enabling customer virtual try-on is at a location convenient to the customer.

21. The system as claimed in claim 17, wherein the means for calibrating a display device for obtaining the facial feature dimensions for fitting is performed by an eye-care professional at a customer location via a web-enabled display device.

22. The system as claimed in claim 21, wherein the means for calibrating a display device is performed by an optician at said customer location.

23. The system as claimed in claim 17, wherein means for enabling customer virtual try-on includes: means for enabling said customer to manipulate said scaled image of said selected eyewear relative to said displayed image of said customer to fit said eyewear to said customer digital image.

24. The system as claimed in claim 23, wherein the means for enabling said customer to manipulate said image of said selected eyewear includes means for enabling lateral or vertical adjustment of said scaled image of said selected eyewear relative to said displayed customer image.

25. The system as claimed in claim 23, wherein the means for enabling said customer to manipulate said image of said selected eyewear includes means for enabling rotational adjustment of said scaled image of the selected eyewear relative to said displayed customer image.

26. The system as claimed in claim 17, wherein the means for enabling said customer virtual try-on of said selected eyewear at said web-enabled customer display device further includes: means for causing for display at the customer display device two images of the customer each image superposed with a different selected eyewear to enable comparison shopping for the customer.

27. The system as claimed in claim 19, further including means for enabling customer purchase of the selected eyewear after virtual try-on.

28. The system as claimed in claim 27, further comprising means for maintaining an account for the customer including personal information of a customer to facilitate said customer purchase and order fulfillment of said selected eyewear.

29. The system as claimed in claim 28, wherein said means for maintaining a customer account comprises:
means for receiving and storing lens prescription for that customer to be used for manufacturing lenses fitted for purchased eyewear;
means for receiving and storing information for billing said customer; and
means for receiving and storing information for delivery of eyewear to the customer, said lens, bill to, and delivery information being used to facilitate purchase and order fulfillment of the selected eyewear by the customer.

30. The system as claimed in claim 29, wherein subsequent to customer purchase of selected eyewear, the means for obtaining further measurements for generating a prescription lens to be fitted for said eyewear according to said customer's prescription, said measurements obtained directly from a displayed image of said selected eyewear superimposed said over said displayed image of said customer.

31. The system as claimed in claim 30, wherein the means for obtaining further measurements for generating prescription lens is performed by an optician from a web-enabled display device at a customer location, said measurements including one or more selected form the group comprising: OD measurement, OS measurement, and a nose bridge measurement.

32. The system as claimed in claim 28, further comprising means for tracking lens and eyewear frame order status for permitting the customer to receive notifications regarding that customer's order.

33. A program storage device readable by machine, tangibly embodying a program of instructions executable by the machine to perform method steps for enabling customer selection of eyewear and try-on over a web-enabled networked computing system, said method steps comprising:
a) obtaining one or more digital images of a customer to be fitted with said eyewear and storing said images;
b) performing a facial image measurement to be used for calibrating a display device to obtain facial feature dimensions for fitting said eyewear to said customer based on the stored customer's image, said measurement being performed at a customer location via an eye-care professional;
c) enabling a customer to select eyewear from a plurality of eyewear choices for virtual try-on via a web-enabled customer display device;
d) enabling customer virtual try-on of said selected eyewear at said web-enabled customer display device by:
i. retrieving said stored digital image of said customer for display at said customer display device;
ii. generating an image of a selected eyewear scaled for fitting said customer according to said obtained facial feature dimensions; and,
iii. generating for display an image of said selected eyewear superimposed over said displayed image of said customer,
wherein a realistic rendition of the customer wearing eyewear fitted for that customer via the customer's web-enabled customer display device is provided.

34. The program storage device as claimed in claim 33, wherein the step b) of performing a facial image measurement to be used for calibrating a display device includes performing a pupillary distance (PD) measurement for that customer at said customer location.

35. The program storage device as claimed in claim 34, wherein said calibrating a display device for obtaining said facial feature dimensions for fitting comprises the steps of:
accessing said stored customer's image and displaying said stored customer's image on a display device;
demarcating two points directly on said displayed customer's image representing a PD measurement; and,
mapping a number of pixels representing a linear distance between said two points on said customer's image with said obtained PD measurement to calibrate said display, wherein further facial feature measurements may be made directly on said customer's displayed image given said mapping.

36. The program storage device as claimed in claim 33, wherein said step of enabling customer virtual try-on includes: enabling said customer to manipulate said scaled image of said selected eyewear relative to said displayed image of said customer to fit said eyewear to said customer digital image.

37. The program storage device as claimed in claim 35, further including the step of enabling customer purchase of said selected eyewear after virtual try-on.

38. The program storage device as claimed in claim 37, further comprising maintaining an account for the customer including personal information of a customer to facilitate said customer purchase and order fulfillment of said selected eyewear.
